(19) United States
(12) Patent Application Publication
(10) Pub. No.: US 2008/0146444 A1
(43) Pub. Date: Jun. 19, 2008

(54) Method and compositions for improving plant growth

(75) Inventors: Jon O. Fabri, Charleston, SC (US); Christopher B. Murphy, Woodridge, IL (US); Jason K. Holt, Ball Ground, GA (US)

Correspondence Address: Marcia T. Greci, Ph.D., Esq.;Nelson Mullins Riley & Scarborough, LLP, 17th Floor, 1320 Main Street, Columbia, SC, 29201, US

(73) Assignee: Polymer Ventures, Inc., Charleston, SC (US)

(21) Appl. No.: 11/642,034

(22) Filed: Dec. 19, 2006

(51) Int. Cl. A01N 27/00; A01N 25/26; A01P 21/00

(52) U.S. Cl. 504/100; 504/357

(57) ABSTRACT

The present invention relates to a method for improving plant growth by adding at least one terpene and one or both of an organic solvent and a surfactant to the growth medium of the plant, and to a composition that is useful for improving plant growth comprising at least one terpene, an organic solvent, and optionally a surfactant.

### BACKGROUND OF THE INVENTION

The present invention relates generally to compositions and methods for improving plant growth. More specifically, the present invention relates generally to the use of terpenes to improve the growth of plants.

Because of the importance of agriculture and horticulture to the production of food and feed, as well as the modification and decoration of the environment, a great deal of research and development has been directed toward methods to control plant growth. Improvement in fertilization, cultivation techniques, pesticides, seed selection, hybrid production, genetic manipulation, and many other areas of technology have created great improvements in plant genetics, plant growth, yield, pest resistance, and soil conditioning and conservation.

Soil microorganisms affect the condition of the soils by influencing water content, nutrient recycling, and diseases. Microorganisms such as bacteria form soil aggregates, which control water movement and retention. Aggregates allow for water movement by increasing the interstitial spaces and minimizing evaporative loss. Other bacteria and fungi are responsible for enabling plants to absorb and fix nitrogen and carbon, promoting growth.

Plant populations depend on soil bacteria to provide them with water and nutrients. In fact, the presence or absence of soil bacteria and the type of soil organisms that are present are determining factors for the types of plants that will grow in a given environment.

Terpenes are natural constituents of essential oils that are typically found in plants. They are the major components of resin, and of turpentine produced from resin. Terpenes are based on five-carbon isoprene (C₅H₈) subunits and can optionally include aromatic rings. Many terpenes are hydrocarbons, but oxygen-containing alcohols, aldehydes, and ketones, known as terpenoids, are also found.

Terpenes and terpenoids are the primary constituents of the essential oils of many types of plants and flowers. Essential oils are used widely as natural flavor additives for food, as fragrances in perfumery, in aroma therapy, and in traditional and alternative medicines. Synthetic variations and derivatives of natural terpenes and terpenoids also greatly expand the variety of aromas used in perfumery and flavors used in food additives.

Terpenes have been found useful in cleaning solutions due to their availability and recyclability. Additionally, terpenes are non-reactive with plastics and metals, making them desirable for their ability to clean without degrading the product being cleaned. In commonly owned, copending U.S. Patent Application No. 60/814,244, the inventors reported the use of terpenes to increase the rate of production and/or the yield of a non-terpene organic compound by a microorganism in a fermentation medium.

Terpenes are widely used as cleaning and decontaminating agents, but few reports have been found of the beneficial use of terpenes in relation to plant growth. In fact, of the U.S. patents or patent publications that mention the use of a terpene such as limonene, most appear to use the terpene to enhance the effectiveness of herbicides (See, e.g., U.S. Pat. Nos. 6,969,696, 6,812,190, 6,759,370, 6,509,297, 6,218,336, 5,998,335, 5,407,899), or as biopesticides (See, e.g., U.S. Pat. Nos. 6,545,043, 6,387,933, or U.S. Patent Publication No. 2003/014454), or repellants (See, e.g., U.S. Pat. No. 5,892,133), or even to inhibit the growth of plants (See U.S. Pat. No. 3,960,539, or U.S. Patent Publication No. 2006/0199739). In fact U.S. Pat. No. 3,960,539, shows that a limonene derivative, cyclopentyl dimethyl (1-hydroxy-p-menth-2-yl)ammonium bromide, inhibited cucumber seed radicle growth even at levels as low as 7-174 ppm (0.00002 M to 0.0005 M). Furthermore, Abrahim et al., in J. Chem. Ecol., 26(3):611-624 (2000), indicated no improvement in seed germination or plant primary root growth from limonene applied at concentrations of 14 ppm to 1400 ppm (0.1-10 millimolar).

In U.S. Patent Publication No. 2004/0248764, compositions that include a terpene solution or suspension in water, optionally with a surfactant, are described for treating and/or preventing disease by an infectious agent in plants. The concentration of the terpene in the compositions of the publication is an anti-infective amount, and ranges from about 20 ppm up to about 5000-10,000 ppm. Tests reported in the specification indicated an incomplete kill of Xylella fastidiosa at 62.5 ppm of citral, and a level of 125 ppm was recommended as the minimum desired concentration to be used for this pest.

It would be useful to provide improved methods and compositions for improving plant growth. It would also be useful to provide an improved method of reducing erosion. It would be particularly useful if such methods and compositions utilized materials that were non-toxic to humans and were non-hazardous and could be applied easily and at low cost.

### SUMMARY OF THE INVENTION

Briefly, therefore, the present invention is direct to a novel method of improving plant growth, the method comprising adding at least one terpene and one or both of a surfactant and an organic solvent to a growth medium of the plant.

The present invention is also directed to a novel composition for improving plant growth, the composition comprising at least one terpene and one or both of a surfactant and an organic solvent, wherein the terpene is present in a concentration of less than 20 ppm by weight.

The present invention is also directed to a novel composition for improving plant growth, the composition comprising at least one terpene, at least one organic solvent, and optionally a surfactant.

The present invention is also directed to a novel method of preventing erosion comprising adding at least one terpene and one or both of an organic solvent and a surfactant to a growth medium that is at risk of erosion; and growing a plant in the growth medium.

The present invention is also directed to a novel material selected from the group consisting of grass sod, grass seeding mix, landscape matting containing plant seed, hydro-seeding mulch, erosion control mats, erosion control blankets, turf reinforcement matting, and bonded fiber matrix for erosion control comprising at least one terpene in a plant growth improving amount.

Among the several advantages found to be achieved by the present invention, therefore, may be noted the provision of improved methods and compositions for improving plant growth, the provision of an improved method of reducing erosion, and the provision of such methods and compositions which utilize non-toxic and non-hazardous materials with methods that can be applied easily and at low cost.

### BRIEF DESCRIPTION OF THE DRAWINGS

FIG. 1 is a photograph of plants grown in accordance with the present invention;

FIG. 2 is a photograph of plants grown in accordance with the present invention;

FIG. 3 is a photograph of plants grown without the present method and composition;

FIG. 4 is a photograph of plants grown in accordance with the present invention;

FIG. 5 is a photograph of root systems of plants grown in accordance with the present invention;

FIG. 6 is a photograph of one plant grown in accordance with the present invention and one plant grown without the present method and composition;

FIG. 7 is a photograph of plants grown without the present method and composition;

FIG. 8 is a photograph of plants grown in accordance with the present invention;

FIG. 9 is a photograph of plants grown in accordance with the present invention;

FIG. 10 is a photograph of plants grown in accordance with the present invention;

FIG. 11 is a photograph of plants grown without the present method and composition;

FIG. 12 is a photograph of plants grown in accordance with the present invention;

FIG. 13 is a photograph of plants grown without the present method and composition;

FIG. 14 is a photograph of plants grown in accordance with the present invention;

FIG. 15 is a photograph of plants grown without the present method and composition;

FIG. 16 is a photograph of plants grown in accordance with the present invention; and

FIG. 17 is a photograph of some plants grown in accordance with the present invention and some plants grown without the present method and composition.

### DETAILED DESCRIPTION OF SEVERAL EMBODIMENTS

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

In accordance with the present invention, it has been discovered that the addition of a terpene and one or both of a surfactant and an organic solvent to the growth medium of a plant improves the growth of the plant. In fact, the inventors have found that, contrary to the teachings of the prior art in which terpenes are used to inhibit or reduce plant growth, the application of at least one terpene and one or both of a surfactant and an organic solvent to soil in which grass seed is planted unexpectedly improves the density of the growing grass and the rate of growth of the grass as compared with grass seeded in the same area but not receiving the novel treatment method even when the terpene is added in amounts significantly below those reported to be effective for pesticidal use.

In one aspect, the invention includes novel compositions for improving plant growth. An embodiment of a composition of the present invention includes at least one terpene, at least one organic solvent and optionally at least one surfactant. In another embodiment, the novel composition includes at least one terpene and one or both of a surfactant and an organic solvent, wherein the terpene is present in a concentration of less than 20 ppm by weight.

The composition may also include additional compounds, such as one or more of linear or branched hydrocarbons, preservatives, viscosity modifiers, wetting agents, tracing agents, dyes, and antifoams.

As used herein, the term “terpene” indicates a compound based on the isoprene unit (C₅H₈) and may be either acyclic or cyclic with one or more benzenoid groups. A terpene may be classified as monocyclic (diterpene), dicyclic (pinene), or acyclic (myrcene) according to the molecular structure. Terpene derivatives (camphor, menthol, terpineol, borneol, geraniol, and the like) are called terpenoids; many are alcohols, but terpenoids can also include aldehydes and ketones. A terpene may also be classified according to the number of isoprene units that are included in the compound. For example, a monoterpene, such as pinene, nerol, citral, camphor, menthol, and limonene, contains 2 isoprene units. A sesquiterpene, such as nerolidol and farnesol, contains 3 isoprene units. A diterpene, such as phytol and Vitamin A1, contains 4 isoprene units. A triterpene, such as squalene, contains 6 isoprene units. A tetraterpene, such as carotene (provitamin A1) contains 8 isoprene units.

In the present invention the terpene can be almost any terpene. In some embodiments, the terpene comprises a monoterpene, sesquiterpene, diterpene, triterpene, tetraterpene, or a mixture of these. In a preferred embodiment, the terpene comprises a monoterpene. Examples of useful monoterpenes include, without limitation, pinene, nerol, citral, camphor, menthol, limonene, and mixtures thereof. Examples of useful sesquiterpenes, without limitation, include nerolidol, farnesol, or a mixture of these. Examples of useful diterpenes include, without limitation, phytol, Vitamin A1, or a mixture of these. Examples of useful triterpenes include, without limitation, squalene. Examples of useful tetraterpenes include, without limitation, carotene.

Terpenoids are also included as terpenes for the purposes of the present invention. The terpene of the present invention can be supplied by compounds such as turpentine and pine oil.

Sources of terpenes such as rosin, citrus fruit, and the materials derived from them such as turpentine, pine oil, orange oil, and the like, can contain other plant-derived chemical components such as fatty acids, triglycerides, sterols, rosins, and furanocoumarins. In some embodiments, it is preferred that the terpene be purified. As used herein, the term “purified” means that the terpene or mixture of terpenes has been purified and increased in concentration to any degree from the natural source in which it is found. By way of example, orange oil or turpentine are purified terpenes, because they contain terpenes in a higher concentration than oranges or pine trees, which are the natural sources for these compounds. In some embodiments, it is preferred that the terpene be “isolated and purified”. As used herein, the term “isolated and purified” means that the terpene has been purified and increased in concentration from the natural source in which it is found and that the concentration of terpenes is at least about 80% by weight of the isolated and purified terpene. Also as used herein, the term “terpenes” may indicate a combination of one or more terpene compounds as defined above. Similarly, a “terpene” may include one or more terpenes, either isolated and purified, purified, or unpurified. Accordingly, a terpene may include one or more terpenes and additional compounds, such as those described above.

In some embodiments it is preferred that the terpene comprise one or more compounds selected from pinene, nerol, citral, camphor, menthol, limonene, nerolidol, farnesol, phytol, geraniol, farnesol, Vitamin A1, squalene, tocopherol, carotene (provitamin A1), careen, linalool, turpentine, or mixtures thereof. In other embodiments, limonene is the preferred terpene. Limonene can be provided in almost any form and purity, as long as other components that are present are not harmful to the plant or plant growth medium on which it is used in the present invention. Examples of limonene sources include citrus oils, such as orange oil, lemon oil, oil of Bergamot, and caraway, for example. A racemic mixture of d- and 1-limonene is useful for the present invention. In some embodiments, d-limonene is preferred. Limonene that is useful in the present invention can be obtained from the plant sources noted above, or it can be purchased as, for example, Aldrich Product No. 18,3164 (Sigma-Aldrich, St. Louis, Mo.). D-limonene (CAS #5989-27-5) is available from Ashland Distribution Co., Columbus, Ohio; Expo Chemical Co., Inc., Houston, Tex.; Florida Chemical Co., Inc., Winter Haven, Fla.; KIC Chemicals Inc., Armonk, N.Y.; and Penta Manufacturing Co., Livingston, N.J.

The terpene of the invention can be used in different physical forms. For example, the terpene can be placed in a carrier vehicle that can take the form of a concentrated liquid, a mixture, or an emulsion. Examples of a concentrated liquid form include oleoresins, extracts, oils, plant distillates, pressates, and the like. Examples of the terpene mixtures include combinations of terpenes with surfactants which can improve dispersion or emulsification in aqueous media, or combinations with organic solvents as residue from extraction processes, as an extender, a diluent, or viscosity reducer. Examples of the terpene emulsion form include oil-in-water or water-in-oil emulsions. In some embodiments, the emulsion is an oil-in-water emulsion that is stabilized against separation with the assistance of surfactants.

The terpene of the invention is preferably supplied in the form of an emulsion. In one embodiment, the emulsion can contain from about 0.1% to about 80% terpenes based on the total weight of the emulsion. In a preferred embodiment, the emulsion contains from 0.5% to 25% terpenes. In a more preferred embodiment, the emulsion contains from about 1% to about 10% terpenes.

In an exemplary embodiment, the terpene is used in the present method in combination with one or both of an organic solvent and one or more surfactants.

Examples of materials that can act as the organic solvent of the present invention include organic hydrocarbons containing about 7 to about 30 carbons; linear or branched alkanes, preferably from C₈ to about C₄₀, more preferably from C₁₀ to C₂₄, including, for example, octane, nonane, decane, undecane, dodecane, tridecane, tetradecane, hexadecane, heptadecane, octadecane, nonadecane, and the like; monounsaturated or polyunsaturated olefins, preferably C₈-C₄₀, more preferably C₁₀-C₂₄, alpha olefins, preferably linear alpha olefins, more preferably C₈-C₄₀ linear alpha olefins, yet more preferably C₁₀-C₂₄ linear alpha olefins, including for example, octene, nonene, decene, undecene, dodecene, tridecene, tetradecene, hexadecene, heptadecene, octadecene, nonadecene, and the like; polybutenes or polyisobutylenes; paraffin oil or mineral oil or wax; fatty esters, preferably lower alkyl (C₁-C₄) esters of fatty acids, more preferably the methyl ester of a vegetable oil such as methyl soyate; triglycerides from animal and vegetable sources; volatile organic liquids with atmospheric pressure boiling points in the range of about 50°-250° C., especially lower alcohols such as methanol, ethanol, propanol, isopropanol, butanol, isobutanol, and the like.

In one embodiment of the invention, the concentration of the organic solvent is from about 0.1% to about 80% of the emulsion, based on the total weight of emulsion. In a preferred embodiment, the organic solvent concentration in the emulsion is about 0.5% to about 25%. In a more preferred embodiment, the surfactant concentration in the emulsion is about 1% to about 10%.

When a surfactant is used, it may reduce interfacial tension, allowing for the formation of small emulsion droplets. The small droplet size may be preferred to minimize the rate of gravity separation of the phases of the emulsion. In one embodiment of the invention, the surfactant concentration is from about 0.5% to about 15% of the emulsion, based on the total weight of emulsion. In a preferred embodiment, the surfactant concentration in the emulsion is about 1% to about 12%. In a more preferred embodiment, the surfactant concentration in the emulsion is about 3% to about 10%.

The surfactant can be a single type, but it is preferred to use a combination of two or more surfactants. It is common to characterize surfactants by a hydrophile-lipophile balance value, also known as HLB value. Surfactants with a low HLB are more lipid loving and thus tend to make a water-in-oil emulsion while those with a high HLB are more hydrophilic and tend to make an oil-in-water emulsion. When combinations of surfactants are used, the weighted average of the individual surfactant components is used to calculate the HLB of the combination. The preferred surfactant combination for the emulsion has an HLB value of about 6 to about 25. More preferred is an HLB of 8 to 20. Yet more preferred is an HLB of 9 to 18. And even more preferred is an HLB of from 11 to 16.

Surfactants that are useful in the present invention include, without limitation, ethoxylated alcohols, ethoxylated carbohydrates, ethoxylated vegetable oils, polyethyleneglycols (PEG), polypropylene glycols (PPG), monoesters and diesters of PEG and PPG, ethoxylated amines, fatty acids, ethoxylated fatty acids, fatty amides, fatty diethanolamides, and the like. Examples of specific surfactants, and commercial sources, include oleyl alcohol 10 EO (Ethox Chemical), Tween 20 (Uniqema), stearyl alcohol 20 EO (Ethox Chemical), castor oil 80 EO (Ethox Chemical), castor oil 30 EO (Ethox Chemical), PEG 400 Dioleate (Ethox Chemical), tallow amine 5 EO (Akzo Nobel), Burco TME-S (Burlington Chemical), coconut diethanolamide (Ethox Chemical), Ethfac 161 (Ethox Chemical), cocoamine 2 EO (Akzo Nobel), cocoamine 5 EO (Akzo Nobel), Dowanol DB (Dow Chemical), Demulse DLN 532 CE (Deforest Enterprises), Tween 80 (Uniqema), Demulse DLN 622 EG (Deforest Enterprises), Span 20 (Uniqema), Diacid 1550 (Westvaco), decyl alcohol 4 EO (Ethox Chemical), dipropyleneglycol methyl ester (Dow Chemical), sodium lauryl sulfate (SLS), sodium dodecyl sulfate (SDS), sodium xylenesulfonate (SXS), and Tergitol NP6 (Dow Chemical).

An example of a useful combination of the terpene and one or both of the surfactant and the organic solvent of the present invention comprises an emulsion comprising water and from about 0.1% to about 80% of a terpene, from about 0.1% to about 80% of an organic solvent, and optionally from about 0.5% to about 15% of a surfactant, all by weight.

In another example, the combination of the terpene and one or both of the surfactant and the organic solvent comprises an emulsion comprising water and from about 0.5% to about 25% of a terpene, from about 1% to about 12% of an organic solvent, and optionally from about 0.5% to about 25% of a surfactant, all by weight.

In yet another example, the combination comprises an emulsion comprising water and from about 1% to about 10% of a terpene, from about 1% to about 10% of an organic solvent, and optionally from about 3% to about 10% of a surfactant, all by weight.

When the combination is prepared for use, it can be diluted with water so that the concentrations of the components in the composition as it is applied to the growth medium are from about 0.03 to about 15 ppm of a terpene, from about 0.03 to about 30 ppm of an organic solvent, and optionally from about 0.03 to about 30 ppm of a surfactant, all in parts of the component per million parts of the total composition.

Another embodiment of the combination as prepared for application to the growth medium comprises water and from about 0.3 to about 15 ppm of a terpene, from about 0.3 to about 15 ppm of an organic solvent, and optionally from about 0.3 to about 15 ppm of a surfactant, with or without other optional additives, all in parts of the component per million parts of the total composition.

Yet another embodiment of the combination as prepared for application to the growth medium comprises water and from about 1 to about 10 ppm of a terpene, from about 1 to about 10 ppm of an organic solvent, and optionally from about 1 to about 10 ppm of a surfactant, with or without other optional additives, all in parts of the component per million parts of the total composition.

In some embodiments, the composition may further include foam control agents, weed control chemicals, plant growth regulators, seeds, viscosity modifiers, drift control additives, cellulose, moisture retention additives, fertilizers, and combinations thereof.

In a preferred embodiment of the present composition, the terpene comprises a monoterpene, sesquiterpene, diterpene, triterpene, tetraterpene, or a mixture of these. In another embodiment, the terpene comprises a monoterpene. The monoterpene can be selected from pinene, nerol, citral, camphor, menthol, limonene, and mixtures thereof. The terpene can also comprise a sesquiterpene. The sesquiterpene can be nerolidol, farnesol, or a mixture of these. The terpene can comprise a diterpene. The diterpene can comprise phytol, Vitamin A1, or a mixture of these. In another embodiment, the terpene comprises a triterpene. The triterpene can be squalene. The terpene can comprise a tetraterpene, such as carotene.

It is preferred that the terpene of the terpene/surfactant composition comprises one or more compounds selected from pinene, nerol, citral, camphor, menthol, limonene, nerolidol, farnesol, phytol, geraniol, farnesol, Vitamin A1, squalene, tocopherol, carotene (provitamin A1), careen, linalool, turpentine, or mixtures thereof. In some instances, it is preferred that the terpene is a purified terpene, and in other instances it is preferred that the terpene is an isolated and purified terpene.

The surfactant of the terpene/surfactant composition can be one or more compounds selected from ethoxylated alcohols, ethoxylated carbohydrates, ethoxylated vegetable oils, polyethyleneglycols (PEG), polypropylene glycols (PPG), monoesters and diesters of PEG and PPG, ethoxylated amines, fatty acids, ethoxylated fatty acids, fatty amides, and fatty diethanolamides. It is preferred that the surfactant has a weighted average HLB value between about 6 and about 25, more preferred is an HLB value between about 8 and about 20, and even more preferred is an HLB value between about 9 and about 18.

Examples of useful surfactants include one or more of oleyl alcohol 10 EO, Tween 20, stearyl alcohol 20 EO, castor oil 80 EO, castor oil 30 EO, PEG 400 Dioleate, tallow amine 5 EO, Burco TME-S, coconut diethanolamide, Ethfac 161, cocoamine 2 EO, cocoamine 5 EO, Dowanol DB, Demulse DLN 532 CE, Tween 80, Demulse DLN 622 EG, Span 20, Diacid 1550, decyl alcohol 4 EO, dipropyleneglycol methyl ester, sodium lauryl sulfate, sodium dodecyl sulfate, sodium xylenesulfonate, and Tergitol NP6.

The present composition can have the form of a solution, a solid, or an emulsion. It is preferred that the composition is in the form of an emulsion, and an oil-in-water emulsion is particularly preferred.

When the composition is an oil-in-water emulsion, it can comprise the terpene and one or both of the organic solvent and the surfactant in the amounts described above. In a particular embodiment, the composition can comprise from about 1% to about 10% by weight of d-limonene, from about 1% to about 10% of a C₁₀-C₂₄ unsaturated linear alpha olefin organic solvent, and/or from about 1% to about 10% by weight of a surfactant comprising one or more of oleyl alcohol 10 EO, Tween 20, stearyl alcohol 20 EO, castor oil 80 EO, castor oil 30 EO, PEG 400 Dioleate, tallow amine 5 EO, Burco TME-S, coconut diethanolamide, Ethfac 161, cocoamine 2 EO, cocoamine 5 EO, Dowanol DB, Demulse DLN 532 CE, Tween 80, Demulse DLN 622 EG, Span 20, Diacid 1550, decyl alcohol 4 EO, dipropyleneglycol methyl ester, sodium lauryl sulfate, sodium dodecyl sulfate, sodium xylenesulfonate, and Tergitol NP6.

In another aspect, the invention is a method of improving plant growth. The method includes introducing at least one terpene and one or both of a surfactant and an organic solvent to a growth medium of a plant. The terpene, the organic solvent and/or the surfactant may be added separately, or they may be added simultaneously in a composition.

Exemplary plant growth media include, but should not be limited to, seeds, cellulose, biosludge solids, compost, soil, sand, vermiculite, potting mixes, bark, fertilizer, grass sod, grass seeding mix, landscape matting containing plant seed, hydro-seeding mulch, erosion control mats, erosion control blankets, turf reinforcement matting, and bonded fiber matrix for erosion control and the like. The growth medium can be in situ, such as soil in the ground, it can be present in a vessel, such as a wheelbarrow or mixer, or it can be in the form of a mulch, blanket or mat. The terpene/surfactant combination may be a liquid absorbed into or adsorbed onto the growth medium. Alternatively, the combination may be a solid mixed into any of the suitable growth media.

The present methods and compositions can be used with any plant. Examples of plants for which the present methods and compositions are useful include plants belonging to bryophyta, hepatophyta, anthrocerophyta, pterophyta, sphenophyta, psilotophyta, gymnosperms such as coniferophyta, ginkophyta, cycadophyta, and gnetophyta, and angiosperms such as antrophyta.

Examples of plants for which the present methods and compositions are useful include agronomic plants such as rice, wheat, barley, rye, potato, carrot, sugar beet, bean, pea, chicory, lettuce, turnip, radish, spinach, asparagus, onion, garlic, eggplant, pepper, celery, canot, squash, pumpkin, zucchini, cucumber, quince, melon, nectarine, apricot, strawberry, grape, pineapple, papaya, mango, banana, soybean, tomato, sorghum and raspberries, banana, soybean, corn (maize), cotton, rape, oilseed rape (including canola), sunflower, alfalfa, clover, sugarcane, and turf; or fruits and vegetables, such as banana, blackberry, blueberry, strawberry, and raspberry, cantaloupe, coffee, grapes, honeydew, onion, peas, peppers, sweet corn, tobacco, tomatillo, watermelon, rosaceous fruits (such as apple, peach, pear, cherry and plum) and vegetable brassicas (such as broccoli, cabbage, cauliflower, Brussels sprouts, and kohlrabi), millet; sorghum; currant; avocado; citrus fruits such as oranges, lemons, grapefruit and tangerines, artichoke, nuts such as the walnut and peanut; endive; leek; roots such as arrowroot, beet, cassaya, turnip, radish, yam, and sweet potato; and beans, woody species, such as pine, poplar and eucalyptus, or mint or other labiates.

The present methods and compositions can be used with legumes (members of the class Magnoliopsida and the order Fabales). The plant can be in the family Fabaceae (formerly Leguminosae) and the sub-family Papilionoideae or Faboideae, and the plant be selected from the group consisting of Pisum spp. (including the garden pea, P. sativum), Medicago spp. (including alfalfa, M. sativa), Arachis spp. (including peanuts, A. hypogaea), soybeans (including Glycine max, Glycine hispida), Vicia spp. (including vetches), Vigna spp. (including cowpeans), Vicia spp. (including fava bean, V. faba), trefoil, clovers and Phaseolus spp. (including P. vulgaris, P. lunatus, P. limensis, and P. coccineus).

The present invention can also be used to benefit angiosperms in class Liliopsida, order Cyperales, and family Poaceae (Gramineae), and in particular, plants of Arundo spp., Arundo donax, Juncus spp., Scirpus spp., Cyperus spp., Carex spp., Erianthus spp., Typha spp, Cynodon dactylon, Digitaria sanguinalis, Erianthus giganteus, Erianthis strictus, Miscanthus sinensis, Paspalum urvillei, Panicum dichotomum, Poacae spp, Setaria gigantea, Sorghum halepense, Spartina alterniflora, Spartina cynosuroides, Spartina pectinata, Spartina spartinae, and Spartina patens of Poaceaea (grasses family); Carex acuta, Carex sp 2, Cyperus esculentus, Cyperus giganteus, Cyperus haspan, Cyperus iria, Cyperus odoratus, Cyperus pseudovegetus, Cyperus retrorsa, Scirpus acutus, Scripus americanus, Scripus californicus, and Scripus validus of Cyperaceae (sedges family); Juncus articulatus, Juncus compressus, Juncus dichotomus, Juncus effusus, Juncus roemerianus, and Juncus tenuis of Juncaceae (rushes family); as well as Typha angustifolia, Typha dominguensis, and Typha latifolia of Typhaceae (cattails family).

The present methods and compositions are particularly useful for grasses. Grasses on which the present invention is useful include, but are not limited to: bluegrass, annual bluegrass, bahiagrass, bentgrass, bermudagrass, fescue, ryegrass, perenneal ryegrass, playground turf, St. Augustine grass, zoysia grass, Congo grass, Brachiaria ruziziensis, and the like.

Exemplary terpenes, exemplary organic solvents and exemplary surfactants useful in the present invention are discussed above. The method may further include adding one or more additional components to the growth medium, including, but not limited to preservatives, viscosity modifiers, solvents, wetting agents, tracing agents, dyes, and antifoams. Optionally, the present composition consists essentially of a terpene, an organic solvent, and optionally a surfactant in a water solution or suspension, and is free of other constituents that would make the composition more complex. This form provides advantages of ease of mixing and application, and offers good economy.

As mentioned above, the at least one terpene and one or both of the organic solvent and the surfactant can be introduced to the growth medium in combination in a composition. Alternatively, the terpene, the organic solvent and/or the surfactant can be introduced to the growth medium separately (i.e., not in combination).

The terpene-containing combination is introduced to the growth medium in an amount that is effective to improve the growth of a plant that is planted and grown in the growth medium (growth improving amount). As used herein, the terms “growth improving amount” refer to the amount of the present combination or composition that when added to a growth medium in which a plant is grown causes any improvement in plant growth no matter how small, such as, but not limited to, increasing the rate and/or the percentage of seed germination, increasing the rate of plant growth, increasing plant mass per unit time, increasing plant height per unit time, increasing the rate of uptake of nutrients by a plant, increasing the density of plants per unit area, increasing the yield of a product from the plant, increasing the resistance of the plant to pests and/or environmental stress, all as compared to plants of the same type grown under the same conditions but without the application of the present invention.

By way of example, when the terpene-containing combination is added to the growth medium it is added in a growth improving amount. In an embodiment of the present method, the terpene-containing composition is added to the growth medium in an amount to provide from about 0.01 to about 25 mg/kg of a terpene, from about 0.01 to about 25 mg/kg of an organic solvent, and optionally from about 0.01 to about 25 mg/kg of a surfactant, all in milligrams of the component per kilogram of growth medium. In another embodiment, the terpene-containing composition is added to the growth medium in an amount to provide from about 0.1 to about 15 mg/kg of a terpene, from about 0.1 to about 15 mg/kg of an organic solvent, and optionally from about 0.1 to about 15 mg/kg of a surfactant, all in milligrams of the component per kilogram of growth medium. In another embodiment, the terpene-containing composition is added to the growth medium in an amount to provide from about 0.5 to about 10 mg/kg of a terpene, from about 0.5 to about 10 mg/kg of an organic solvent, and from about 0.5 to about 10 mg/kg of a surfactant, all in milligrams of the component per kilogram of growth medium.

The composition of the present invention may be added to the growth medium at regular intervals, for example, at the time of fertilizer or other chemical treatment applications. Alternatively, the present composition may be applied by dilution into irrigation water. Application methods may include spraying, flooding, dripping, misting, seeding, spreading, and combinations thereof. Additionally, the composition may be applied before and/or at the time of seeding or about the time of expected germination of the seeds.

In an additional embodiment, the present composition may be applied as a composition absorbed into or adsorbed onto solids. These solids may be seeds, mulch, soil, sand, vermiculite, potting mix, bark, moss, cellulose, reclaimed waste products or sludges, hay, sawdust, textiles, or mesh fabrics. The composition may also be coated or encapsulated to allow slow release after application. Examples of exemplary slow release formulas include waxes, polymers, porous minerals, cellulose, microcapsules, microparticles, and the like.

The concentration of terpene in the present composition may be as low as 0.03 ppm, such as the method of dilution in irrigation water. It may be desirable to add the terpene at a higher concentration if applied as a mist or spray. In sprayed applications, the terpene might be present at concentrations of less than about 20 ppm by weight. For ease of spray application and economic use of the additives, however, it may be preferred to spray apply a diluted liquid containing from about 0.03 ppm to about 15 ppm total terpene. Preferably, the sprayed liquid contains in the range of about 0.3 to about 15 ppm, or about 1 to about 10 ppm total terpenes. In certain applications, the liquid contains less than about 20 ppm of the terpene on a weight basis, less than 18 ppm is preferred, and less than 15 ppm is more preferred.

When the composition of the present invention is applied in liquid slurry seeding or hydroseed mixtures, the terpene concentration in the composition may be about 0.01 to about 25 mg/kg of the growth medium, preferably from about 0.1 to about 15 mg/kg, and more preferably from about 0.1 to about 10 mg/kg of the growth medium.

The present composition is preferably added in a plant growth improving amount. When one embodiment of the present method is used to treat a growth medium such as soil in situ, the rates of use that provide a growth improving amount comprise from about 0.1 to about 1000 milligrams of terpene per square meter of surface of the growth medium (mg/m²), from about 0.1 to about 1000 mg/m² of organic solvent, and optionally from about 0.1 to about 1000 mg/m² of a surfactant, all in milligrams of the component per unit surface area of the growth medium to be treated. In a preferred embodiment the growth improving amount is an amount that provides from about 1 to about 200 milligrams of terpene per square meter of surface of the growth medium (mg/m²), from about 1 to about 200 mg/m² of organic solvent, and optionally from about 1 to about 200 mg/m² of a surfactant, all in milligrams of the component per unit surface area of the growth medium to be treated. In a yet more preferred embodiment the growth improving amount is an amount that provides from about 5 to about 100 milligrams of terpene per square meter of surface of the growth medium (mg/m²), from about 5 to about 100 mg/m² of organic solvent, and optionally from about 5 to about 100 mg/m² of a surfactant, all in milligrams of the component per unit surface area of the growth medium to be treated. In a still more preferred embodiment the growth improving amount is an amount that provides from about 5 to about 75 milligrams of terpene per square meter of surface of the growth medium (mg/m²), from about 5 to about 75 mg/m² of organic solvent, and optionally from about 5 to about 75 mg/m² of a surfactant, all in milligrams of the component per unit surface area of the growth medium to be treated. In a still more preferred embodiment the growth improving amount is an amount that provides from about 5 to about 30 milligrams of terpene per square meter of surface of the growth medium (mg/m²), from about 5 to about 30 mg/m² of organic solvent, and optionally from about 5 to about 30 mg/m² of a surfactant, all in milligrams of the component per unit surface area of the growth medium to be treated.

These same amounts can be expressed in terms of pounds per acre of land surface area (lb/ac) as: 0.001 to about 10 lb/ac of each of a terpene and one or more of an organic solvent and a surfactant, preferably from about 0.01 to about 2 lb/ac of each of a terpene and one or more of an organic solvent and a surfactant, and more preferably from about 0.05 to about 1 lb/ac of each of a terpene and one or more of an organic solvent and a surfactant. This treatment amount can be applied in a single application or in multiple applications over time during the growth of the plants being treated.

As previously stated, the present composition and method of the invention can contain other adjuvants without departing from the scope of the invention. Examples of these adjuvants include preservatives, viscosity modifiers, solvents, wetting agents, tracing agents, dyes, antifoams, weed control chemicals, plant growth regulators, seeds, drift control additives, cellulose, moisture retention additives, fertilizers, and combinations thereof.

Those having ordinary skill in the art will recognize that the success of the present method may be observed by increased plant growth evident in the portion of the plant growing outside the growth medium. The success may also be observed in the portion of the plant growing within the growth medium, e.g., the roots.

In another aspect, the present invention is a method of preventing erosion. The method includes increasing the rate of seed germination and growth of plants and root systems in plant growth medium which is at risk of erosion by adding at least one terpene and at least one surfactant to the growth medium that is at risk of erosion, and then growing a plant in the growth medium.

The present invention also encompasses the treatment of grass sod, grass seeding mix, landscape matting containing plant seed, hydro-seeding mulch, erosion control mats, erosion control blankets, turf reinforcement matting, bonded fiber matrix for erosion control as well as plant seed and propagation material with at least one terpene of the type described herein, or preferably at least one terpene and at least one surfactant, both of the respective types described herein, or more preferably with at least one terpene, at least one surfactant, and at least one organic solvent, all of the respective types described herein. Also envisioned as being included in the present invention is grass sod, grass seeding mix, landscape matting containing plant seed, hydro-seeding mulch, erosion control mats, erosion control blankets, turf reinforcement matting, bonded fiber matrix for erosion control, and plant seed and/or propagation material to which has been added at least one terpene of the type and in the amount described herein, or preferably at least one terpene and at least one surfactant, both of the respective types and amounts described herein, or more preferably with at least one terpene, at least one surfactant, and at least one organic solvent, all of the respective types and amounts described herein.

Exemplary methods for adding the at least one terpene and one or both of an organic solvent and a surfactant to a growth medium for a plant, as well as exemplary terpene, organic solvent, and surfactant components are discussed above.

Exemplary plant growth media that is subject to erosion include one or more of hillsides, landscaped areas, road banks, stream banks, beaches, barren soil, and cleared areas. As used herein, the term “cleared areas” includes fields, forest, hillsides, and other areas where natural growth has been cleared.

The following examples describe preferred embodiments of the invention. Other embodiments within the scope of the claims herein will be apparent to one skilled in the art from consideration of the specification or practice of the invention as disclosed herein. It is intended that the specification, together with the examples, be considered to be exemplary only, with the scope and spirit of the invention being indicated by the claims which follow the examples. In the examples all percentages are given on a weight basis unless otherwise indicated.

### EXAMPLE 1

This example illustrates formulations of several embodiments of the terpene-containing oil-in-water emulsion of the present invention. Emulsions A-Q were prepared by first dispersing the surfactants in water, followed by addition of the terpene with vigorous mixing.

| | Wt % |
|---|---|
| Composition A | |
| d-limonene | 5.0 |
| oleyl alcohol 10 EO | 4.5 |
| Tween 20 | 3.0 |
| Water | balance |
| Composition B | |
| d-limonene | 5.0 |
| oleyl alcohol 10 EO | 6.75 |
| Span 20 | 0.75 |
| Water | balance |
| Composition C | |
| d-limonene | 5.0 |
| hexadecene | 5.0 |
| stearyl alcohol 20 EO | 15.0 |
| castor oil 80 EO | 5.0 |
| water | balance |
| Composition D | |
| d-limonene | 5.0 |
| isoparaffin | 5.0 |
| stearyl alcohol 20 EO | 15.0 |
| castor oil 80 EO | 5.0 |
| water | balance |
| Composition E | |
| d-limonene | 10.0 |
| Tergitol NP6 | 6.0 |
| Diacid 1550 | 4.0 |
| dipropyleneglycol methyl ester | 2.0 |
| water | balance |
| Composition F | |
| d-limonene | 5.0 |
| Diacid 1550 | 3.0 |
| decyl alcohol 4 EO | 3.0 |
| dipropyleneglycol methyl ester | 2.0 |
| water | balance |
| Composition G | |
| d-limonene | 5.0 |
| Dowanol DB | 2.0 |
| Demulse DLN 532 CE | 8.0 |
| Water | balance |
| Composition H | |
| d-limonene | 5.0 |
| Dowanol DB | 5.0 |
| Demulse DLN 622 EG | 5.0 |
| Water | balance |
| Composition I | |
| d-limonene | 10.0 |
| Span 20 | 3.75 |
| Tween 80 | 1.25 |
| Water | balance |
| Composition J | |
| d-limonene | 5.0 |
| Cocoamine 2 EO | 3.5 |
| Cocoamine 5 EO | 3.5 |
| Water | balance |
| Composition K | |
| d-limonene | 5.0 |
| coconut diethanolamide | 8.0 |
| Ethfac 161 | 1.6 |
| PEG 400 Dioleate | 5.0 |
| Water | balance |
| Composition L | |
| d-limonene | 5.0 |
| Ethomeen T-15 | 4.0 |
| Burco TME-S | 4.0 |
| Water | balance |
| Composition M | |
| d-limonene | 7.0 |
| mineral oil | 7.0 |
| Ethomeen T-15 | 6.0 |
| Burco TME-S | 6.0 |
| Water | balance |
| Composition N | |
| d-limonene | 7.0 |
| castor oil 30 EO | 5.7 |
| PEG 400 dioleate | 2.7 |
| Water | balance |
| Composition O | |
| d-limonene | 3.0 |
| castor oil 30 EO | 5.7 |
| PEG 400 dioleate | 2.7 |
| Water | balance |
| Composition P | |
| d-limonene | 3.0 |
| hexadecene | 4.0 |
| castor oil 30 EO | 5.7 |
| PEG 400 dioleate | 2.7 |
| Water | balance |
| Composition Q | |
| d-limonene | 30.0 |
| polyacrylic acid | 0.2 |
| triethanolamine | 0.3 |
| water | balance |

### EXAMPLE 2

This example demonstrates the efficacy of an embodiment of the present method in improving the growth of grass.

Grass growth studies were conducted with the formulation of Composition P of Example 1. In these tests, 8-place plastic plant trays were used to germinate and grow grass seed indoors under artificial light. In each growth test, 80 g of Scotts® Enriched LawnSoil was placed in the container, followed by 2.9 g of Scotts® Pure Premium® High Performance Grass Seed Mixture. This was topped with 20 g Scotts® Lawn Soil to cover the seeds to a depth of about 1.5 cm. The surface area of each individual test was 0.091 sq ft. The tray of test specimens was lighted with a Phillips 2″×48″ Fluorescent plant light 14 hours per day at 40 Watts or 1600 Lumens.

The grass seed variety used was Scofts® Pure Premium® High Performance Grass Seed Mixture, with the following composition:

### Pure Seed Variety/Kind Germination

36.47% Majesty Perennial Ryegrass/90%

22.65 Abbey Kentucky Bluegrass/85%

19.45% Inspire Perennial Ryegrass/90%

19.40% Pentium Perennial Ryegrass/90%

### Other Ingredients:

0.25% Other Crop Seed

1.78% Inert Matter

0.01% Weed Seed

The blank (untreated) test was watered with 75 mL of tap water. The tests containing treatments were dosed with 75 mL of solutions of Composition P. This provided the same moisture level in all tests, whether treated or untreated. In the table below, the dosages are expressed both as grams of Composition P formulation per square foot of treated area, and as parts per million concentration of the formulation in the initial watering. Each test was watered with 30 ml of tap water once weekly thereafter. The treatment with the formulation of Composition P was repeated at day 7 and day 15 during watering. Again, total water addition to each test was held constant.

Results of treatment with the formula of Composition P:

| | | | |
|---|---|---|---|
| Initial | Initial | 7 days | 14 days |
| Treatment | Treatment | Grass height | Grass height |
| Dose (g/sqft) | (ppm) | (cm) | (cm) |

| | | | |
|---|---|---|---|
| 0.000 | 0 | 8.0 | 15 |
| 0.016 | 20 | 8.5 | 15 |
| 0.041 | 50 | 9.0 | 15 |
| 0.082 | 100 | 8.5 | 15 |
| 0.164 | 200 | 8.0 | 15 |

FIG. 1 shows growth test results with Composition P treatment at 7 days elapsed time. The growth cells having 20, 50, 100, and 200 ppm initial treatment dose are shown from left to right, and the maximum grass growth is evident at 50 ppm treatment level.

This result shows the improvement in growth resulting from treatment with the terpene containing formulation of Composition P.

After 27 days growth in the tests described above, the grass sections were removed from the tray to allow inspection of the root systems. The plant roots were thicker and denser in the treated grass tests compared to the control.

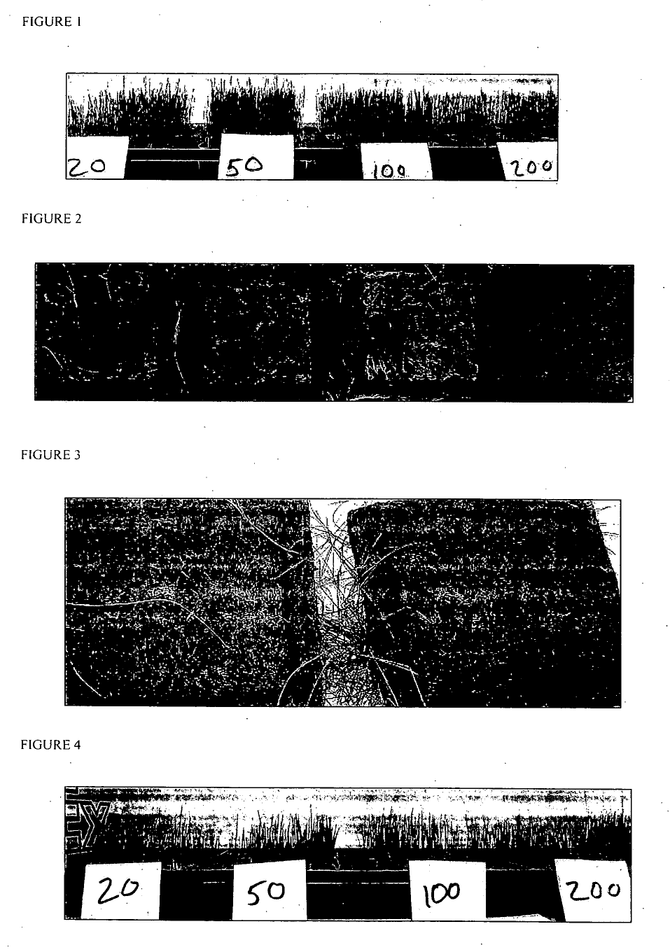

In FIG. 2, a dose profile of grass treated with Composition P at 20, 50, 100, and 200 ppm (shown left to right) is provided. As can be seen, initial dosage shows highest root density at 100 ppm dose after 27 days elapsed time.

The 27-day root growth in two untreated (control) growth tests is shown in FIG. 3. By comparison, the roots are less dense and thinner in the control tests vs. the treated tests.

### EXAMPLE 3

This example illustrates the efficacy of an embodiment of the present method on grass growth improvement.

Grass growth studies were conducted with the formulations of Composition N of Example 1. The test conditions were the same as described for Example 2. The results of the study are shown in the table below.

Results of treatment with the formula of Example N:

| Initial | Initial | 7 days | 14 days |
|---|---|---|---|
| Treatment | Treatment | Grass ht. | Grass ht. |
| Dose (g/sqft) | (ppm) | (cm) | (cm) |
| 0.000 | 0 | 8.0 | 15 |
| 0.016 | 20 | 8.5 | 15 |
| 0.041 | 50 | 8.5 | 15 |
| 0.082 | 100 | 8.0 | 15 |
| 0.164 | 200 | 8.0 | 15 |

FIG. 4 demonstrates the growth results of grass treated with Composition N at 7 days. As can be seen, the effects on grass growth rates were less pronounced than in Example 2, but still showed an improvement in growth at 50 and 100 ppm initial dosage of the terpene containing formulation of Composition N.

FIG. 5 is a photo of root systems of grasses demonstrating the effects of a dose profile (20, 50, 100, 200 ppm left to right) of Composition N. The highest root density appears at 200 ppm dose after 27 days elapsed time.

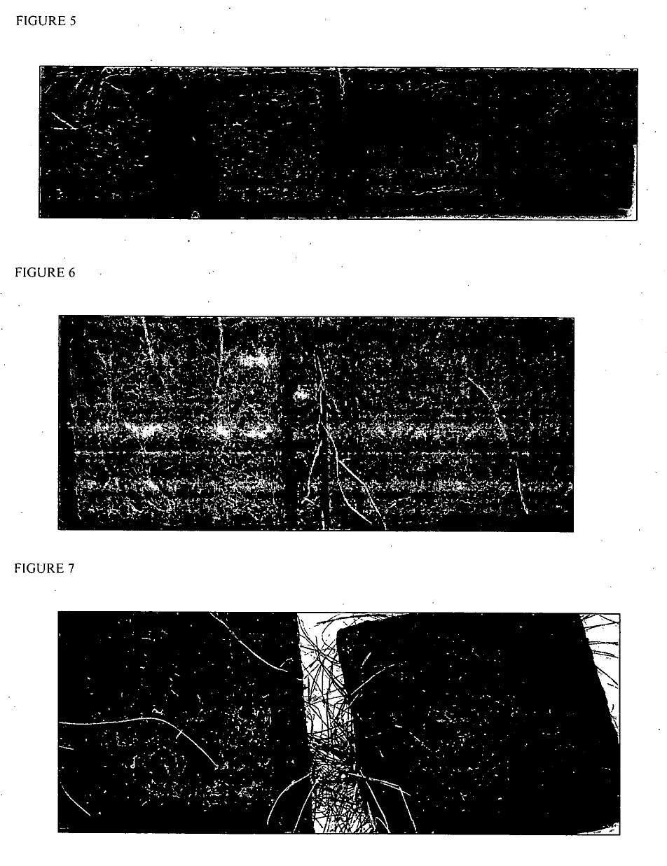

In FIG. 6, the 200 ppm dose level is shown on the left, and an untreated control is on the right. Root density is significantly higher in the test treated with 200 ppm of the formulation of Composition N.

The 27-day root growth in the two untreated (control) growth tests is shown in FIG. 7. Both control tests had less dense root growth compared to the treated tests.

### EXAMPLE 4

This example illustrates an embodiment of the present method in which Composition P was used to treat growth medium in which grass seed was planted.

An outdoor planter test was conducted in USDA Plant Hardiness Zone 8A. Two adjacent sections of 8.5″×15.5″ outside planters (0.915 sq ft) were edged with bricks and the two sides were planted with equal portions of grass seed. One section (the left section) was the control, watered with 800 ml of water at the beginning, and the other section (the right section) was dosed with 800 ml of a 200 ppm solution of the formula in Composition P. The dose level was equivalent to 0.175 grams of Composition P per square foot or 16.8 pounds per acre. Both sides received the same amount of water at the beginning. The planters were not disturbed after the initial dosing, and they were allowed to grow under ambient conditions of temperature, humidity, moisture, and lighting. Photographs of the growth results were taken 27, 32, and 36 days after planting.

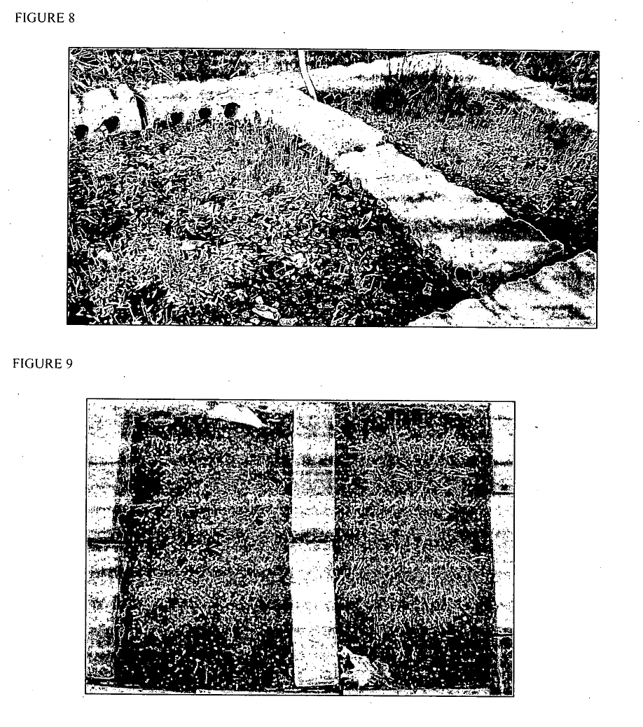

FIG. 8 shows grass growth results at 27 days after planting, with improved results on the treated (right) side.

FIG. 9 shows grass growth results at 32 days after planting, with improved results on the treated (right) side.

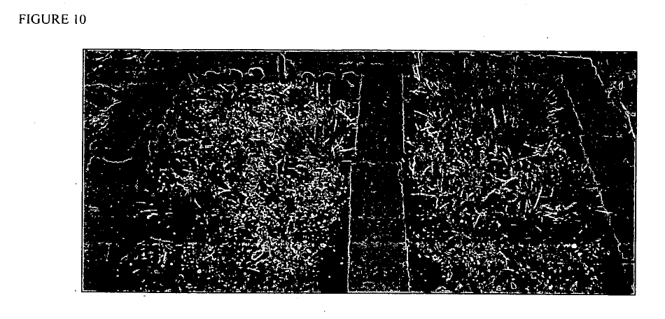

FIG. 10 shows improved grass growth is continued in the treated (right) side at 36 days after planting.

FIGS. 8-10 show that higher grass density, more viable plants, faster growth, and taller grass result from the treatment with the formulation of Composition P as compared with the grass grown under the same conditions, but without the addition of Composition P.

### EXAMPLE 5

This example illustrates an embodiment of the present method in which Composition P was used to treat growth medium in which grass seed was planted.

Outdoor hydroseeding tests were done in USDA Plant Hardiness Zone 8A. Two adjacent sections of hillside were hydroseeded using commercial hydroseed application equipment and typical application procedures. The areas were seeded to prevent erosion of the soil on the hillside, and the hydroseed was applied late in the growing season, in September. The untreated (control) section of the test plot was seeded with a standard hydroseeding mixture. The treated section was seeded with a modified hydroseeding mixture containing 100 ppm of the formulation of Composition P. All other ingredients in the treated and untreated hydroseed mixtures were otherwise the same.

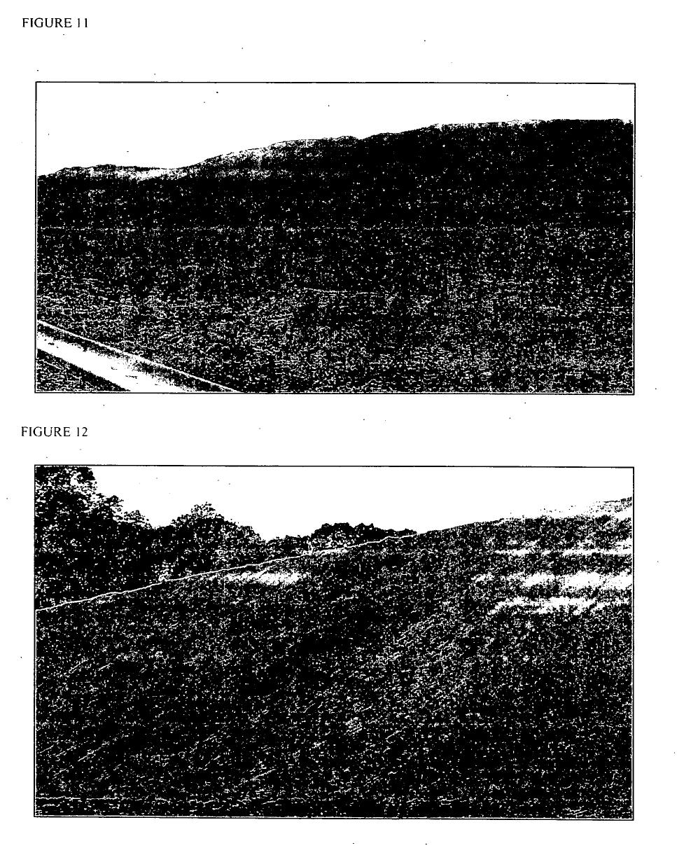

FIG. 11 shows results 7 days after planting of the untreated (control) hydroseed section. Scattered germination is observed.

FIG. 12 shows results 7 days after planting of the treated hydroseed section. There is widespread germination with some dense sections of growth.

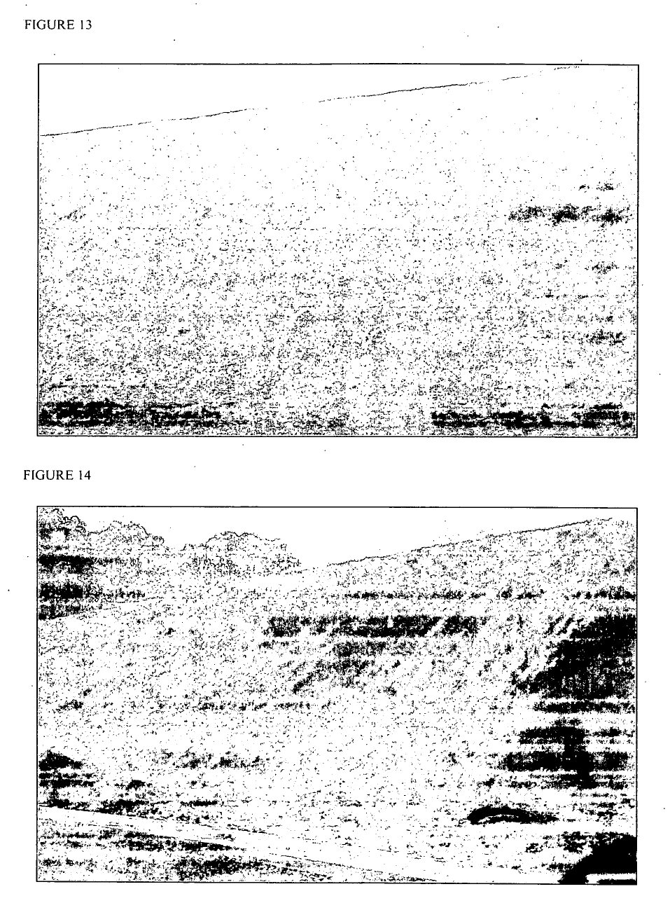

FIG. 13 shows results 13 days after planting of the untreated (control) hydroseed section.

FIG. 14 shows results 13 days after planting of the treated hydroseed section.

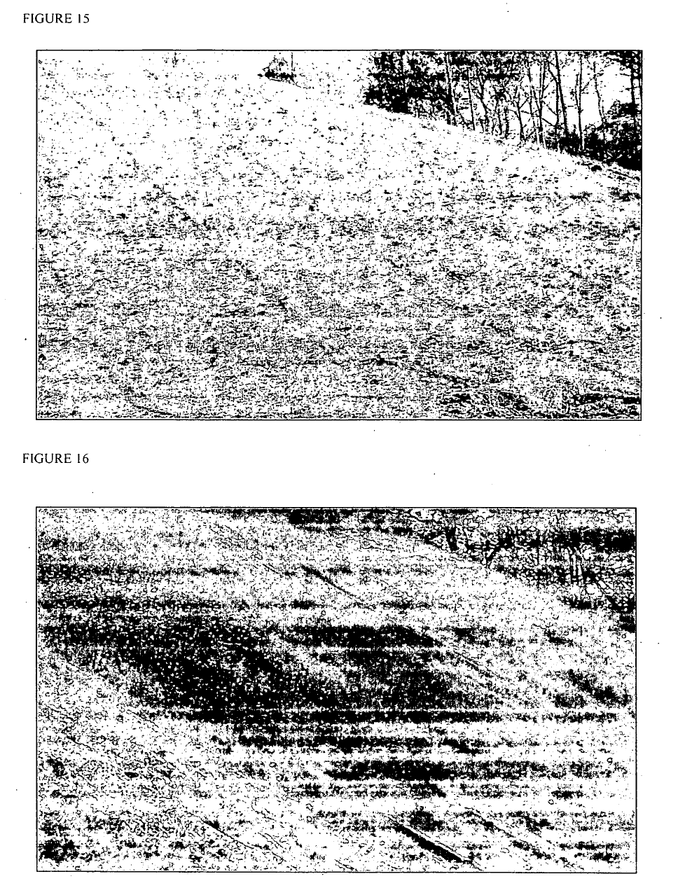

FIG. 15 shows results 20 days after planting of the untreated (control) hydroseed section.

FIG. 16 shows results 20 days after planting of the treated hydroseed section.

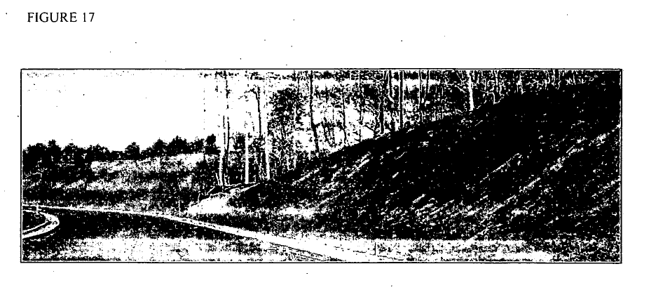

In FIG. 17, the section treated with Composition P is seen in the foreground (right) and the control section is in the background (left), both at 20 days growth time. The treated section contained 100 ppm of the formulation in Composition P in the hydroseed mixture, as applied. Since Composition P contains 3% of the terpene d-limonene, the treatment level in Example 5 is 3 ppm of total terpenes, based on the hydroseed mixture as applied. The treated section showed higher germination rates and thicker grass. This improvement in grass growth is expected to result in better erosion control, better drought resistance, and decreased losses of seed to birds, rodents, insects, and the like.

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties.

The discussion of the references herein is intended merely to summarize the assertions made by their authors and no admission is made that any reference constitutes prior art. Applicants reserve the right to challenge the accuracy and pertinency of the cited references.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of the various embodiments may be interchanged both in whole or in part.

What is claimed is:

1. A method of improving plant growth, the method comprising adding at least one terpene and one or both of a surfactant and an organic solvent to a growth medium of the plant.

2. The method according to claim 1, wherein the terpene is selected from the group consisting of monoterpenes, sesquiterpenes, diterpenes, triterpene, tetraterpenes, and combinations thereof.

3. The method according to claim 1, wherein the terpene is selected from the group consisting of pinene, nerol, citral, camphor, menthol, limonene, nerolidol, farnesol, phytol, geraniol, farnesol, Vitamin A₁, squalene, tocopherol, carotene (provitamin A₁), careen, linalool, turpentine, and mixtures thereof.

4. The method according to claim 1, wherein the terpene comprises an isolated and purified terpene.

5. The method according to claim 1, comprising adding a surfactant that is selected from the group consisting of ethoxylated alcohols, ethoxylated carbohydrates, ethoxylated vegetable oils, polyethyleneglycols (PEG), polypropylene glycols (PPG), monoesters and diesters of PEG and PPG, ethoxylated amines, fatty acids, ethoxylated fatty acids, fatty amides, fatty diethanolamides, and combinations thereof.

6. The method according to claim 5, wherein the surfactant or combination of surfactants has an HLB value between about 7 and about 25.

7. The method according to claim 5, wherein the surfactant or combination of surfactants has an HLB value between about 9 and 18.

8. The method according to claim 5, wherein the surfactant or combination of surfactants has an HLB value between about 11 and 16.

9. The method according to claim 5, wherein the surfactant is selected from the group consisting of oleyl alcohol 10 EO, Tween 20, stearyl alcohol 20 EO, castor oil 80 EO, Burco TME-S, coconut diethanolamide, Ethfac 161, cocoamine 2 EO, cocoamine 5 EO, Dowanol DB, Demulse DLN 532 CE, Tween 80, Dumulse DLN 622 EG, Span 20, Diacid 1550, decyl alcohol 4 EO, dipropyleneglycol method ester, sodium lauryl sulfate, sodium dodecyl sulfate, sodium xylenesulfonate, Tergitol NP6, and combinations thereof.

10. The method according to claim 1, comprising adding an organic solvent that is selected from the group consisting of linear or branched alkanes from about C₈ to about C₄₀ carbon atoms, monounsaturated or polyunsaturated olefins, C₁₀-C₂₀ linear alpha olefins, polyisobutylenes, paraffin oil, mineral oil, mineral wax, fatty esters, lower alkyl (C₁-C₄) esters of fatty acids, methyl esters of a vegetable oil, methyl soyate, triglycerides from animal and vegetable sources, volatile organic liquids with atmospheric pressure boiling points in the range of about 50° C. to about 250° C., lower alcohols, and combinations thereof.

11. The method according to claim 10, wherein the organic solvent comprises one or more C₁₀-C₂₄ linear alpha olefins that are selected from the group consisting of octene, nonene, decene, undecene, dodecene, tridecene, tetradecene, hexadecene, heptadecene, octadecene, and nonadecene.

12. The method according to claim 5, comprising adding an organic solvent that is selected from the group consisting of linear or branched alkanes from about C₈ to about C₄₀ carbon atoms, monounsaturated or polyunsaturated olefins, C₁₀-C₂₀ linear alpha olefins, polyisobutylenes, paraffin oil, mineral oil, mineral wax, fatty esters, lower alkyl (C₁-C₄) esters of fatty acids, methyl esters of a vegetable oil, methyl soyate, triglycerides from animal and vegetable sources, volatile organic liquids with atmospheric pressure boiling points in the range of about 50° C. to about 250° C., lower alcohols, and combinations thereof.

13. The method according to claim 1, comprising adding the at least one terpene and one or both of the surfactant and the organic solvent to the growth medium before the plant is planted.

14. The method according to claim 1, comprising adding the at least one terpene and one or both of the surfactant and the organic solvent to the growth medium when the plant is planted.

15. The method according to claim 1, comprising adding the at least one terpene and one or both of the surfactant and the organic solvent to the growth medium after the plant is planted.

16. The method according to claim 1, wherein the at least one terpene and one or both of the surfactant and the organic solvent are added as a composition that comprises the at least one terpene and one or both of the surfactant and the organic solvent.

17. The method according to claim 16, wherein the composition further comprises one or more of fertilizers, herbicides, insecticides, preservatives, viscosity modifiers, solvents, wetting agents, tracing agents, dyes, and antifoams.

18. The method according to claim 16, wherein the composition is in the form of a solid, a solution, or an emulsion.

19. The method according to claim 16, wherein composition is in the form of an oil-in-water emulsion.

20. The method according to claim 16, wherein the composition is an emulsion comprising water and from about 0.1% to about 80% of a terpene, from about 0.1% to about 80% of an organic solvent, and optionally from about 0.5% to about 15% of a surfactant, all by weight.

21. The method according to claim 16, wherein the composition is an emulsion comprising water and from about 0.5% to about 25% of a terpene, from about 0.5% to about 25% of an organic solvent, and optionally from about 1% to about 12% of a surfactant, all by weight.

22. The method according to claim 16, wherein the composition is an emulsion comprising water and from about 1% to about 10% of a terpene, from about 1% to about 10% of an organic solvent, and optionally from about 3% to about 10% of a surfactant, all by weight.

23. The method according to claim 16, wherein the composition is added to the growth medium in a plant growth improving amount.

24. The method according to claim 16, the composition is added to the growth medium in an amount to provide from about 0.01 to about 25 mg/kg of the terpene, from about 0.01 to about 25 mg/kg of the organic solvent, and optionally from about 0.01 to about 25 mg/kg of the surfactant, based on the weight of the growth medium.

25. The method according to claim 16, the composition is added to the growth medium in an amount to provide from about 0.1 to about 15 mg/kg of the terpene, from about 0.1 to about 15 mg/kg of the organic solvent, and optionally from about 0.1 to about 15 mg/kg of the surfactant, based on the weight of the growth medium.

26. The method according to claim 16, the composition is added to the growth medium in an amount to provide from about 0.5 to about 10 mg/kg of the terpene, from about 0.5 to about 10 mg/kg of the organic solvent, and optionally from about 0.5 to about 10 mg/kg of the surfactant, based on the weight of the growth medium.

27. The method according to claim 1, wherein the step of adding the at least one terpene and one or both of the surfactant and the organic solvent to a growth medium comprises adding the at least one terpene and one or both of the surfactant and the organic solvent to soil.

28. The method according to claim 5, wherein the at least one terpene is d-limonene and the at least one surfactant is castor oil 30 EO.

29. A composition for improving plant growth, the composition comprising at least one terpene and one or both of a surfactant and an organic solvent, wherein the terpene is present in a concentration of less than about 20 ppm by weight.

30. A composition for improving plant growth, the composition comprising at least one terpene, at least one organic solvent, and optionally a surfactant.

31. The composition according to claim 30, wherein the terpene is selected from the group consisting of monoterpenes, sesquiterpenes, diterpenes, triterpenes, tetraterpenes, and combinations thereof.

32. The composition according to claim 30, wherein the terpene is selected from the group consisting of pinene, nerol, citral, camphor, menthol, limonene, nerolidol, farnesol, phytol, geraniol, farnesol, Vitamin A₁, squalene, tocopherol, carotene (provitamin A₁), careen, linalool, turpentine, and mixtures thereof.

33. The composition according to claim 30, wherein the composition comprises a surfactant that is selected from the group consisting of ethoxylated alcohols, ethoxylated carbohydrates, ethoxylated vegetable oils, polyethyleneglycols (PEG), polypropylene glycols (PPG), monoesters and diesters of PEG and PPG, ethoxylated amines, fatty acids, ethoxylated fatty acids, fatty amides, fatty diethanolamides, and combinations thereof.

34. The composition according to claim 33, wherein the surfactant or combination of surfactants has an HLB value between about 9 and 18.

35. The composition according to claim 33, wherein the surfactant or combination of surfactants has an HLB value between about 11 and 16.

36. The composition according to claim 33, wherein the surfactant comprises one or more of oleyl alcohol 10 EO Tween 20, stearyl alcohol 20 EO, castor oil 80 EO, Burco TME-S, coconut diethanolamide, Ethfac 161, cocoamine 2 EO, cocoamine 5 EO, Dowanol DB Demulse DLN 532 CE, Tween 80, Dumulse DLN 622 EG, Span 20, Diacid 1550, decyl alcohol 4 EO, dipropyleneglycol method ester, sodium lauryl sulfate, sodium dodecyl sulfate, sodium xylenesulfonate, and Tergitol NP6.

37. The composition according to claim 30, wherein the organic solvent comprises one or more compounds selected from organic hydrocarbons containing about 7 to about 30 carbons, linear or branched alkanes, monounsaturated or polyunsaturated olefins, polybutenes, polyisobutylenes, paraffin oil, mineral oil, wax, fatty esters, triglycerides from animal and vegetable sources, and volatile organic liquids with atmospheric pressure boiling points in the range of about 50°-250° C.

38. The composition according to claim 30, wherein the organic solvent comprises one or more compounds selected from linear or branched alkanes from about C₈ to about C₄₀ carbon atoms.

39. The composition according to claim 30, wherein the organic solvent comprises one or more monounsaturated or polyunsaturated C₁₀-C₂₄ linear alpha olefins.

40. The composition according to claim 30, wherein the organic solvent comprises one or more compounds selected from the group consisting of octene, nonene, decene, undecene, dodecene, tridecene, tetradecene, hexadecene, heptadecene, octadecene, and nonadecene.

41. The composition according to claim 30, wherein the organic solvent comprises one or more compounds selected from the group consisting of methanol, ethanol, propanol, isopropanol, butanol, isobutanol, and the like.

42. The composition according to claim 30, wherein the composition is in the form of a solid, a solution, or an emulsion.

43. The composition according to claim 30, wherein the composition is in the form of an oil-in-water emulsion.

44. The composition according to claim 30, wherein the composition is an emulsion comprising water and from about 0.1% to about 80% of the terpene, from about 0.1% to about 80% of the organic solvent, and optionally from about 0.5% to about 15% of the surfactant, all by weight.

45. The composition according to claim 30, wherein the composition is an emulsion comprising water and from about 0.5% to about 25% of the terpene, from about 0.5% to about 25% of the organic solvent, and optionally from about 1% to about 12% of the surfactant, all by weight.

46. The composition according to claim 30, wherein the composition is an emulsion comprising water and from about 1% to about 10% of the terpene, from about 1% to about 10% of the organic solvent, and optionally from about 3% to about 10% of the surfactant, all by weight.

47. The composition according to claim 30, wherein the at least one terpene is present in a concentration of less than about 20 ppm by weight.

48. The composition according to claim 46, wherein the at least one terpene is d-limonene and the at least one surfactant is castor oil 30 EO.

49. A method of preventing erosion comprising adding at least one terpene and one or more of an organic solvent and a surfactant to a growth medium that is at risk of erosion; and growing a plant in the growth medium.

50. The method of claim 49, wherein the growth medium that is at risk of erosion is selected from one or more of hillsides, landscaped areas, road banks, stream banks, beaches, and cleared areas.

51. A material selected from the group consisting of grass sod, grass seeding mix, landscape matting containing plant seed, hydro-seeding mulch, erosion control mats, erosion control blankets, turf reinforcement matting, and bonded fiber matrix for erosion control comprising at least one terpene in a plant growth improving amount.

52. The material of claim 51, additionally comprising at least one surfactant which in combination with the at least one terpene is present in a plant growth improving amount.

53. The material of claim 52, additionally comprising at least one organic solvent which in combination with the at least one terpene and the at least one surfactant is present in a plant growth improving amount.
